(19) United States
(12) Patent Application Publication
(10) Pub. No.: US 2012/0049826 A1
(43) Pub. Date: Mar. 1, 2012

(54) SYSTEM AND METHOD OF ADAPTIVE SLOPE COMPENSATION FOR VOLTAGE REGULATOR WITH CONSTANT ON-TIME CONTROL

(75) Inventors: Calvin H. Hsu, San Jose, CA (US); Weihong Qiu, San Jose, CA (US); Ruchi J. Parikh, Mountain View, CA (US); Jun Liu, Sunnyvale, CA (US)

(73) Assignee: INTERSIL AMERICAS INC., Milpitas, CA (US)

(21) Appl. No.: 13/004,636

(22) Filed: Jan. 11, 2011

Related U.S. Application Data
(60) Provisional application No. 61/378,815, filed on Aug. 31, 2010.

(51) Int. Cl. G05F 1/575

(52) U.S. Cl. 323/284

(57) ABSTRACT

A system and method including providing an error voltage indicative of output voltage error, generating an off ramp voltage while a pulse control signal is turned off and otherwise resetting the off ramp voltage, developing the off ramp voltage to have a slope which is inversely proportional to an off time of the pulse control signal, comparing the off ramp voltage with the error voltage and turning on the pulse control signal when the off ramp voltage compares favorably with the error voltage, generating an on ramp voltage while a pulse control signal is turned on and otherwise resetting the on ramp voltage, developing the on ramp voltage with a slope that is proportional to the input voltage, and comparing the on ramp voltage with the reference voltage and turning off the pulse control signal when the on ramp voltage compares favorably with the reference voltage.

### CROSS-REFERENCE TO RELATED APPLICATIONS

This application claims the benefit of U.S. Provisional Application Ser. No. 61/378,815, filed on Aug. 31, 2010, which is hereby incorporated by reference in its entirety for all intents and purposes.

### BRIEF DESCRIPTION OF THE DRAWINGS

The benefits, features, and advantages of the present invention will become better understood with regard to the following description, and accompanying drawings where:

FIG. 1 is a simplified schematic and block diagram of a voltage regulator implemented according to one embodiment which uses constant on-time control;

FIG. 2 is a timing diagram illustrating a possible internal solution by developing the TOFF_RAMP voltage during the off time interval of PWM to represent the voltage ripple of the equivalent series resistance of the output capacitor;

FIG. 3 is a timing diagram similar to FIG. 2 except including V_{IN} (and excluding Q2 CURRENT) in which V_{IN} varies from a lower voltage to a higher voltage over time;

FIG. 4 is a timing diagram illustrating an exemplary configuration in which the TOFF_RAMP voltage has a relatively constant peak magnitude for different voltage levels of V_{IN} and thus for different duty cycles of PWM;

FIG. 5 is a schematic diagram of networks illustrating an implementation of simulating output voltage level using input voltage and duty cycle of the pulse modulation control signal;

FIG. 6 is a schematic diagram of an exemplary configuration of the TON comparator network of FIG. 1;

FIG. 7 is a schematic diagram of an exemplary configuration of the TOFF comparator network of FIG. 1 according to one embodiment;

FIG. 8 is a simplified block diagram of an exemplary embodiment of the control network of FIG. 7 for developing the control signal CTL for developing the TOFF RAMP voltage; and

FIG. 9 is a simplified block diagram of a correction network used to provide a correction factor for reducing error in developing the off ramp voltage.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

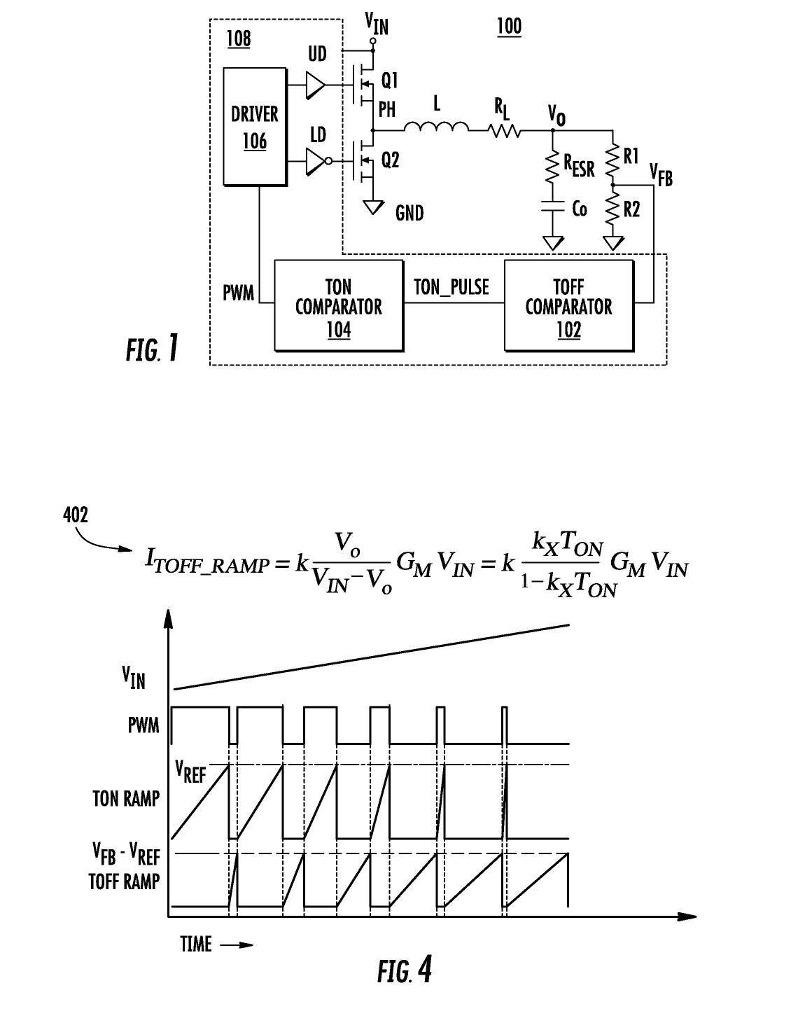

FIG. 1 is a simplified schematic and block diagram of a voltage regulator 100 implemented according to one embodiment which uses constant on-time control. A pair of electronic switches Q1 and Q2 are coupled in series between an input voltage V_{IN} and a reference node, such as ground (GND). An intermediate phase node PH of the switches Q1 and Q2 is coupled to one end of an output inductor L, having its other end coupled to an output node developing an output voltage V_{O}. A resistor R_{L} is shown coupled between L and V_{O} and represents the DC resistance (DCR) of the output inductor L (and thus is inherent within L). An output capacitor C_{O} is coupled between V_{O} and GND. A resistor R_{ESR} is shown coupled in series with C_{O} and represents the equivalent series resistance (ESR) of the output capacitor C_{O} (and thus is inherent within C_{O}). In one embodiment, the capacitor C_{O} is configured as a multilayer ceramic capacitor (MLCC) or the like. A voltage divider including resistors R1 and R2 coupled in series between V_{O} and GND divides V_{O} to provide a feedback voltage V_{FB}, which is provided to an off time (TOFF) comparator network 102. The TOFF comparator network 102 develops an off ramp voltage TOFF_RAMP and compares TOFF_RAMP with V_{FB} (or a version thereof) and provides an on time (TON) pulse signal TON_PULSE to an on time (TON) comparator network 104. The TON comparator network 104 receives the TON_PULSE signal, develops an on ramp voltage TON RAMP, compares TON RAMP with a reference voltage V_{REF}, and generates the PWM signal as further described below.

PWM is provided to the input of a driver network 106, which asserts a first drive signal to an upper driver UD and asserts a second drive signal to a lower driver LD. The output of the upper driver UD drives the gate of Q1 and the output of the lower driver LD drives the gate of Q2. UD is shown as a non-inverting buffer driver and LD is shown as an inverting buffer driver. As illustrated by this simplified configuration, the driver 106 turns Q1 on and turns Q2 off when PWM is high, and turns Q1 off and then turns Q2 on when PWM is low for each cycle of PWM. It is understood that other timing circuitry (not shown) may be used to ensure that both switches Q1 and Q2 are not simultaneously turned on. A bootstrap circuit (not shown) may be provided to enable UD to drive the gate voltage of Q1 above the voltage level of V_{IN}. The electronic switches Q1 and Q2 are each shown as an N-channel metal-oxide semiconductor, field-effect transistor (MOSFET), although other types of electronic switches are contemplated, such as other N-type transistor devices or P-type transistor devices or the like.

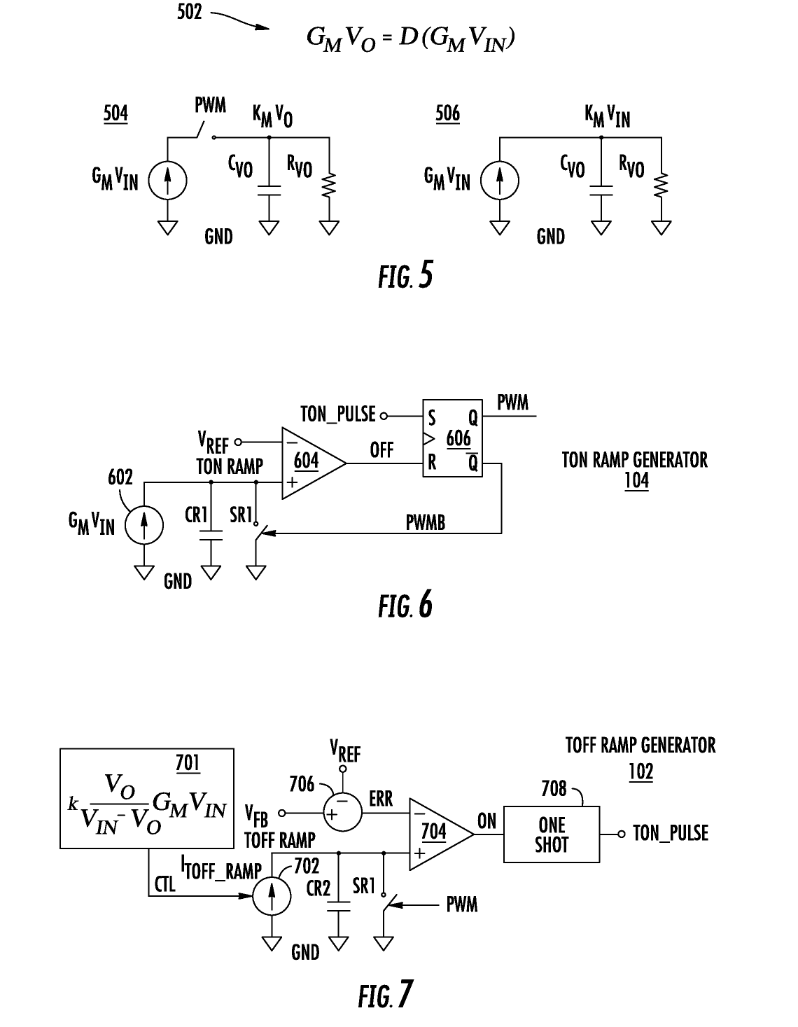

The TOFF comparator network 102, the TON comparator network 104, the driver network 106 and the drivers UD and LD are shown included within a controller 108. The controller 108 may be implemented as an integrated circuit (IC) or the like in which the networks and circuitry are integrated onto a semiconductor die or chip as understood by those skilled in the art. V_{IN} is provided to an input or pin of the controller 108. In another embodiment, the electronic switches Q1 and Q2 are also provided on the controller 108 in which the controller 108 includes an input/output (I/O) pin or the like for coupling to the phase node PH. R1 and R2 sense the output voltage V_{O} for providing the feedback or sense voltage V_{FB} to the controller 108. It is noted that since R1 and R2 may be externally provided from the controller 108 in some embodiments, the actual level of V_{O} may not be known. In one embodiment, V_{O} is also provided directly to an input or pin of the controller 108 for directly determining the level of V_{O}. Alternatively, an output voltage simulation network 504 (FIG. 5) is provided on the controller 108 to simulate or otherwise indirectly derive V_{O} from V_{IN} and the duty cycle of PWM as further described below.

DC-DC voltage regulators with constant on-time control are relatively simple and are very popular schemes for lower cost regulator designs. Conventional regulators with constant on-time control generally have relatively poor frequency control. Also, conventional regulators with constant on-time control may include an output voltage ripple and slope compensation circuit which negatively impacts DC regulation accuracy. Stability is strongly influenced if not generally determined by the R_{ESR} of the output capacitor C_{O}. The magnitude of the ripple voltage of V_{FB} is much lower than the ripple voltage of the output voltage V_{O} because of the voltage divider in the feedback path. Large ripple voltage, however, is generally desired at the comparator inputs in the feedback circuit. A slope compensation circuit is desired in an MLCC design because of very low ripple voltage. Thus, an artificial ripple voltage is desired to augment the ESR-generated voltage ripple. External and internal solutions have been used to develop the artificial ripple voltage.

One external configuration is to insert a small-valued resistor (e.g., 1Ω) in series with the output capacitor C_{O}. Another external configuration is to add a resistor-capacitor (RC) circuit across the inductor L to use the ripple developed across R_{L}. Another external solution is to develop the ripple based on voltage of the phase node PH. Each of these external solutions causes negative impacts on system performance or characteristics including ripple, DC regulation and transient response.

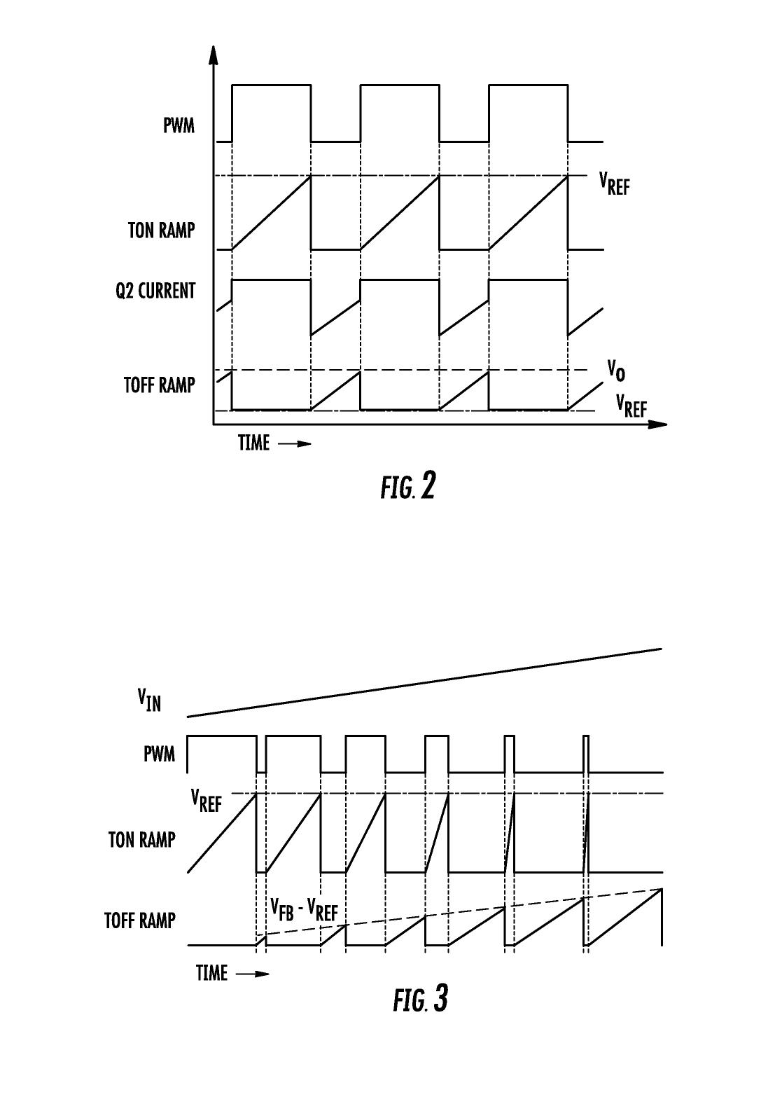

FIG. 2 is a timing diagram illustrating a possible internal solution by developing the TOFF RAMP voltage during the off time interval of PWM to represent the voltage ripple of R_{ESR}. As shown in FIG. 2, PWM, TON RAMP, the current of Q2 or Q2 CURRENT, and TOFF RAMP are plotted versus time. In this case, an artificial ripple is designed with a constant slope using the ripple of the current through the lower switch Q2. In each cycle, the TON RAMP voltage starts at an initial voltage (e.g., GND or 0V) at the start of each PWM pulse and rises at a constant rate (constant slew rate or slope) until it reaches the reference voltage V_{REF}, and then resets back to the initial voltage. Then TOFF RAMP rises at constant slew rate (constant slope) from V_{REF} to V_{O} (or a voltage indicative of output voltage) while PWM is low. When TOFF RAMP reaches V_{O}, the next PWM pulse is initiated and TOFF RAMP goes back to its initial value. Operation repeats in this manner and each PWM pulse is illustrated having the same duration. In this case, the slew rate of TOFF RAMP is relatively constant, and represents the slope of the inductor current during the off time (TOFF), or when PWM is low.

FIG. 3 is a timing diagram similar to FIG. 2 except including V_{IN} (and excluding Q2 CURRENT) in which V_{IN} varies from a lower voltage to a higher voltage over time. Also, TOFF RAMP rises from a lower value, such as GND or 0 Volts to a difference value V_{FB}−V_{REF} (achieving similar results). As shown by the timing diagram of FIG. 3, the peak magnitude of TOFF RAMP varies with the off time, which is varied with changes of V_{IN}. As shown, as V_{IN} rises, the slope of the TON ramp increases causing the on-time and the duty cycle of the PWM pulses to decrease, which means that the on time TON decreases while the off time TOFF increases in respective cycles of PWM. The peak magnitude of TOFF RAMP becomes smaller with lower V_{IN}. A different peak magnitude of TOFF RAMP, however, may negatively impact the DC regulation. Under the maximum duty cycle, the peak magnitude of TOFF RAMP may be too low. In one configuration, for example, if the peak magnitude of TOFF RAMP is chosen to be 1% of V_{REF} when TOFF=TSW (desired switching time), then when TOFF is 5% of TSW, the peak magnitude of TOFF RAMP is 0.05% of V_{REF}, which is very low.

FIG. 4 is a timing diagram illustrating an exemplary configuration in which the TOFF RAMP voltage has a relatively constant peak magnitude for different voltage levels of V_{IN} and thus for different duty cycles of PWM. As shown in FIG. 4, as V_{IN} rises causing an increase of the off time period of PWM, the slope of TOFF RAMP is changed to compensate for the change of the off time duration while maintaining a relatively constant peak magnitude. Thus, the off ramp voltage has a slope which is inversely proportional to an off time of PWM. The relatively constant peak magnitude of TOFF RAMP provides a similar timing offset as shown in FIG. 3 but achieves better DC regulation because of the relatively constant peak level. In one embodiment as illustrated at 402, a ramp current I_{TOFF}_{_{—}}_{RAMP} is generated to achieve the desired off time ramp voltage TOFF RAMP according to the following equation (1):

$${I}_{TOFF\_RAMP} = k \frac{{V}_{O}}{{V}_{IN} - {V}_{O}} {G}_{M} {V}_{IN} = k \frac{{k}_{X} {T}_{ON}}{1 - {k}_{X} {T}_{ON}} {G}_{M} {V}_{IN} \qquad ( 1 )$$

in which k, k_{X} and G_{M} are arbitrary constants or gain values and T_{ON} is the on time for PWM. It is noted that if only V_{IN} is sensed for the TON RAMP voltage, i.e., G_{M}V_{IN} is available and V_{O} is not directly available, then the output voltage V_{O} can be calculated or otherwise determined using the duty cycle D of PWM and the input voltage V_{IN} according to the following equation (2):

G_{M}V_{O}=D(G_{M}V_{IN}) (2)

FIG. 5 is a schematic diagram of networks 504 and 506 illustrating an implementation of equation (2). It is noted that PWM switches according to a duty cycle D. As shown by network 506, a current source develops a current proportional to V_{IN}, shown as gain G_{M} times V_{IN}, where this current is applied across an RC network including a capacitor C_{VO} coupled in parallel with a resistor R_{VO}. The voltage of the RC network develops a voltage proportional to the input voltage V_{IN}, shown as k_{M}V_{IN}. G_{M} and k_{M} are simply arbitrary gain constants each having any suitable value depending upon circuit implementations. The output voltage simulation network 506 is similar to network 504, except that network 504 includes a switch inserted between the current source and the RC network and controlled by the PWM signal. The switch controlled by PWM has the effect of multiplying k_{M}V_{IN} by the duty cycle D, resulting in a voltage k_{M}V_{O} which is proportional to the output voltage V_{O} in accordance with equation (2).

FIG. 6 is a schematic diagram of an exemplary configuration of the TON comparator network 104 according to one embodiment. A capacitor CR1 is charged by a current source 602 providing a current G_{M}V_{IN} when a switch SR1 is opened. The voltage of the capacitor CR1 develops the TON RAMP voltage which is provided to a non-inverting input of a comparator 604. The inverting input of the comparator 604 receives the reference voltage V_{REF}, and the output of the comparator 604 develops an OFF signal which is provided to the reset input of an SR flip-flop (SRFF) 606. The TON_PULSE signal is provided to the set input of SRFF 606 for initiating each pulse on the PWM signal at the Q output of the SRFF 606 with each pulse on TON_PULSE. The inverted Q output (QB) develops an inverted PWM signal PWMB, which generally has the opposite state of PWM, and which is provided to control the switch SR1. When PWM is high and PWMB is low, the switch SR1 is opened and capacitor CR1 is charged at G_{M}V_{IN} causing TON RAMP to ramp up. When the voltage of TON RAMP reaches the voltage of V_{REF}, the comparator 604 asserts OFF high resetting the SRFF 606 so that PWM goes low and PWMB goes high. When PWMB goes high, the switch SR1 is closed discharging the voltage on the capacitor CR1 so that TON RAMP is reset back to its initial voltage, such as GND. The next pulse of the TON_PULSE signal causes PWM to go high and PWMB to go low for the next cycle. Operation repeats in this manner for developing the PWM signal.

FIG. 7 is a schematic diagram of an exemplary configuration of the TOFF comparator network 102 according to one embodiment. A current source 702 develops a current I_{TOFF}_{_{—}}_{RAMP} according to equation (1) previously described. The current charges a capacitor CR2 when a switch SR2 is opened. The voltage of the capacitor CR2 develops the TOFF RAMP voltage, which is provided to a non-inverting input of another comparator 704. In this configuration, V_{REF} is subtracted from V_{FB} (or V_{FB}−V_{REF}) by an error network 706, which outputs a corresponding error signal ERR to the inverting input of the comparator 704. The error network 706 may be implemented as an adder or an amplifier or the like and may have any corresponding gain. In one embodiment, ERR=V_{FB}−V_{REF}. The output of the comparator 704 is provided to an input of a one-shot device 708, having an output providing pulses on the TON_PULSE signal. PWM is provided to the control input of the switch SR2. When PWM is high, the switch SR2 is closed discharging the capacitor CR2 to an initial value (e.g., GND) so that TOFF RAMP is pulled low. When PWM goes low, SR2 is opened and the current source 702 charges the capacitor CR2 causing TOFF RAMP to ramp up based on the current I_{TOFF}_{_{—}}_{RAMP}, which is based on V_{IN} and V_{O}. As previously described, TOFF RAMP has a slope which is inversely proportional to the off time of PWM. When the voltage of TOFF RAMP reaches ERR, the comparator 704 asserts ON high and the one-shot device 708 outputs a pulse on the TON_PULSE signal. As previously described, a pulse on TON_PULSE causes the TON comparator network 104 to initiate the next pulse on PWM (PWM goes high). In one embodiment, a control network 701 develops a control signal CTL provided to a control input of the current source 702 which develops the current I_{TOFF}_{_{—}}_{RAMP} in accordance with equation (1).

The respective operations of the TOFF comparator network 102 and the TON comparator network 104 are described with reference to the timing diagram of FIG. 4. When PWM is high, PWMB is low so that switch SR1 is opened and TON RAMP rises towards V_{REF}. While PWM is high, switch SR2 is closed so that TOFF RAMP remains low. When the voltage of TON RAMP reaches the voltage of V_{REF}, the comparator 604 switches resetting the SRFF 606 pulling PWM low and PWMB high. At this time, switch SR1 is closed and switch SR2 is opened, so that TON RAMP stays low while TOFF RAMP rises. The slope of TOFF RAMP is determined in accordance with equation (1), in which the slope is inversely proportional to the off time of PWM. It is noted that the slope of TOFF RAMP decreases as V_{IN} increases as shown in FIG. 4 so that it rises more slowly to compensate for the longer time period, thus maintaining a relatively constant peak value. When the voltage of TOFF RAMP reaches a voltage related to V_{O} (e.g., V_{FB}−V_{REF}), the comparator 704 pulls its output high causing the one-shot device 708 to generate a pulse on the TON_PULSE signal. The pulse on TON_PULSE causes the SRFF 606 to pull PWM high and PWMB low, so that switch SR1 is opened and switch SR2 is closed and TON RAMP rises while TOFF RAMP stays low for the next cycle. Operation repeats in this manner as shown in FIG. 4.

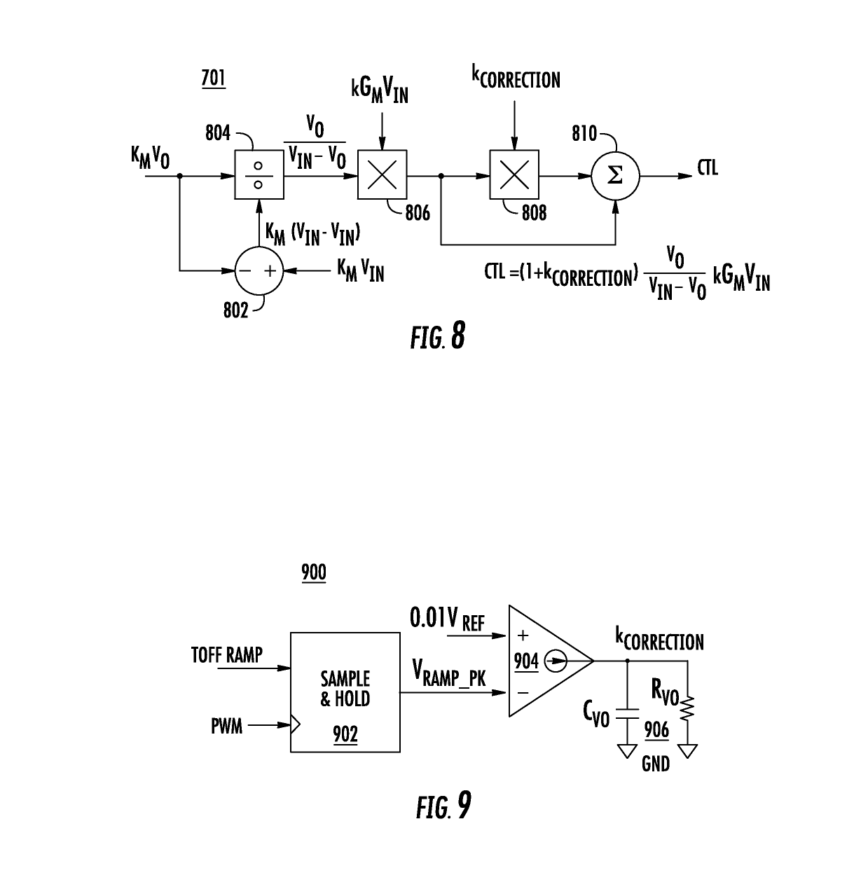

FIG. 8 is a simplified block diagram of an exemplary embodiment of the control network 701 for developing the control signal CTL for controlling the current source 702 to charge the capacitor CR2 to develop the TOFF RAMP voltage. The input voltage V_{IN} and the output voltage V_{O} are each multiplied by an arbitrary constant k_{M}. An adder 802 subtracts k_{M}V_{O} from k_{M}V_{IN} and provides the difference k_{M}(V_{IN}−V_{O}) to one input of a divider 804. The divider 804 divides k_{M} V_{O} by the difference k_{M} (V_{IN}−V_{O}) and provides the value V_{O}/(V_{IN}−V_{O}) to one input of a multiplier 806. The multiplier 806 receives a value kG_{M}V_{IN} at another input, in which k is another selected or arbitrary constant and G_{M} is generally a gain factor. The output of the multiplier 806 provides the value kG_{M} X V_{IN}(V_{O}/(V_{IN}−V_{O})) in accordance with equation (1) to an input of a multiplier 808 and to an input of an adder 810. The multiplier 808 receives a correction factor k_{CORRECTION} at another input and provides the product to another input of the adder 810. The adder 810 adds (or otherwise combines) the outputs of the multipliers 806 and 808 together to provide the output control signal CTL of the control network 701. The k_{CORRECTION} factor is provided to reduce or otherwise eliminate errors that may be introduced by the divider 804 and/or the multiplier 806. In one embodiment, CTL has a value according to equation (3):

$$CTL = ( 1 + {k}_{CORRECTION} ) \frac{{V}_{O}}{{V}_{IN} - {V}_{O}} {kG}_{M} {V}_{IN} \qquad ( 3 )$$

FIG. 9 is a simplified block diagram of a correction network 900 used to provide the k_{CORRECTION} factor for reducing error that may be introduced by the divider 804 and/or the multiplier 806. A sample and hold device 902 samples TOFF RAMP upon each rising edge of PWM (used as the clock input) to output a peak voltage of TOFF RAMP, shown as V_{RAMP}_{_{—}}_{PK}. V_{RAMP}_{_{—}}_{PK} is provided to the inverting input of a transconductance amplifier 904 receiving a value 0.01 V_{REF} at its non-inverting input. The transconductance amplifier 904 outputs a current proportional to the difference of its inputs (e.g., V_{RAMP}_{_{—}}_{PK}−0.01V_{REF}) to an RC circuit 906 including a resistor R_{VO} and a capacitor C_{VO} coupled in parallel between the output of the transconductance amplifier 904 and GND. The capacitor C_{VO} develops a voltage used as the k_{CORRECTION} factor provided to the multiplier 808.

The resistors R1 and R2 are selected to divide the desired level of the output voltage V0 to provide V_{FB} at about the same voltage as V_{REF}. In one embodiment, V_{IN} has a relatively wide voltage range, such as several Volts (e.g., 6V) to several tens of Volts (e.g., about 100V) or more. The voltage regulator 100 regulates the output voltage V_{O} to a target voltage level within the wide range of input voltage. The peak voltage of TOFF RAMP remains relatively constant over the wide range of V_{IN} to ensure desired regulation of V_{O} to within a suitable tolerance level.

A controller for controlling conversion of an input voltage to an output voltage according to one embodiment includes an error device, an off ramp generator, an on ramp generator, an off ramp comparator, an on ramp comparator, and a pulse control network. The error device compares a feedback voltage representing a level of the output voltage with a reference voltage and provides an error voltage indicative thereof. The off ramp generator generates an off ramp voltage while a pulse control signal is off and resets the off ramp voltage while the pulse control signal is on. The off ramp voltage has a slope which is inversely proportional to an off time of the pulse control signal. The off ramp comparator compares the error voltage with the off ramp voltage and asserts an on signal. The on ramp generator generates an on ramp voltage while the pulse control signal is on and resets the on ramp voltage while the pulse control signal is off. The on ramp voltage has a slope which is proportional to the input voltage. The on ramp comparator compares the on ramp voltage with the reference voltage and asserts an off signal. The pulse control network turns on the pulse control signal upon each assertion of the on signal and turns off the pulse control signal upon each assertion of the off signal.

In one embodiment, the off ramp voltage is proportional to the input voltage multiplied by the output voltage divided by a difference between the input voltage and the output voltage. An output voltage simulation network may be included to develop a voltage indicative of the output voltage based on the input voltage and a duty cycle of the pulse control signal. The controller may be provided on an integrated circuit or the like.

A constant on-time voltage regulation system according to one embodiment includes an error network, an off ramp network, an on ramp network, and a pulse control network. The error network compares a feedback voltage indicative of an output voltage with a reference voltage and provides an error voltage indicative thereof. The off ramp network includes an off ramp generator and a comparator. The off ramp generator generates an off ramp voltage while a pulse control signal is turned off and resets the off ramp voltage while the pulse control signal is turned on. The off ramp voltage has a slope which is inversely proportional to an off time of the pulse control signal. The comparator asserts an on signal when the off ramp voltage compares favorably with the error voltage. The on ramp network includes an on ramp generator and a comparator. The on ramp generator generates an on ramp voltage while a pulse control signal is turned on and resets the on ramp voltage while the pulse control signal is turned off. The on ramp voltage has a slope which is proportional to the input voltage. The second comparator asserts an off signal when the on ramp voltage compares favorably with the reference voltage. The pulse control network turns on the pulse control signal upon each assertion of the on signal and turns off the pulse control signal upon each assertion of the off signal.

A method of controlling conversion of an input voltage to an output voltage according to one embodiment includes receiving a sense voltage indicative of the output voltage, comparing the sense voltage with a reference voltage and providing an error voltage indicative thereof, generating an off ramp voltage while a pulse control signal is turned off and resetting the off ramp voltage while the pulse control signal is turned on, developing the off ramp voltage to have a slope which is inversely proportional to the off time of the pulse control signal, comparing the off ramp voltage with the error voltage and turning on the pulse control signal when the off ramp voltage compares favorably with the error voltage, generating an on ramp voltage while a pulse control signal is turned on and resetting the on ramp voltage while the pulse control signal is turned off, developing the on ramp voltage with a slope that is proportional to the input voltage, and comparing the on ramp voltage with the reference voltage and turning off the pulse control signal when the on ramp voltage compares favorably with the reference voltage.

Although the present invention has been described in considerable detail with reference to certain preferred versions thereof, other versions and variations are possible and contemplated. Those skilled in the art should appreciate that they can readily use the disclosed conception and specific embodiments as a basis for designing or modifying other structures for providing the same purposes of the present invention without departing from the spirit and scope of the invention as defined by the following claim(s).

1. A controller for controlling conversion of an input voltage to an output voltage, said controller comprising:
an error device which compares a feedback voltage representing a level of the output voltage with a reference voltage and which provides an error voltage indicative thereof;
an off ramp generator which generates an off ramp voltage while a pulse control signal is off and which resets the off ramp voltage while said pulse control signal is on, wherein the off ramp voltage has a slope which is inversely proportional to an off time of said pulse control signal;
an off ramp comparator which compares said error voltage with said off ramp voltage and which asserts an on signal;
an on ramp generator which generates an on ramp voltage while said pulse control signal is on and which resets said on ramp voltage while said pulse control signal is off, wherein said on ramp voltage has a slope which is proportional to the input voltage;
an on ramp comparator which compares said on ramp voltage with said reference voltage and which asserts an off signal; and
a pulse control network which turns on said pulse control signal upon each assertion of said on signal and which turns off said pulse control signal upon each assertion of said off signal.

2. The controller of claim 1, wherein said off ramp generator comprises:
a current source which develops an off ramp current proportional to the input voltage multiplied by the output voltage divided by a difference between the input voltage and the output voltage; and
a capacitance which is charged by said off ramp current.

3. The controller of claim 2, further comprising an output voltage simulation network which develops a voltage indicative of the output voltage based on the input voltage and a duty cycle of said pulse control signal.

4. The controller of claim 2, wherein said current source comprises:
a controlled current source having a control input;
a combiner which subtracts a first value indicative of the output voltage from a second value indicative of the input voltage to provide a difference value;
a divider which divides said first value by said difference value to provide a third value; and
a multiplier network which multiplies said third value by a fourth value indicative of the input voltage to determine a control value provided to said control input of said controlled current source.

5. The controller of claim 2, wherein said current source comprises:
a controlled current source having a control input;
a combiner which subtracts a first value indicative of the output voltage from a second value indicative of the input voltage to provide a difference value;
a divider which divides said first value by said difference value to provide a third value;
a first multiplier which multiplies said third value by a fourth value indicative of the input voltage to provide a fifth value;
a second multiplier which multiples said fifth value by a correction factor to provide said sixth value; and
a combiner which combines said fifth and sixth values to provide a control value provided to said control input of said controlled current source.

6. The controller of claim 5, further comprising:
a sample and hold network which samples said off ramp voltage based on said pulse control signal to provide a peak off ramp value; and
an amplifier network which amplifies a difference between said peak off ramp value and a reference value proportional to said reference voltage to provide said correction factor.

7. The controller of claim 1, wherein said error device, said off ramp generator, said off ramp comparator and said pulse control network are integrated onto a semiconductor die.

8. A constant on-time voltage regulation system, comprising:
an error network which compares a feedback voltage indicative of an output voltage with a reference voltage and which provides an error voltage indicative thereof;
an off ramp network, comprising:
an off ramp generator which generates an off ramp voltage while a pulse control signal is turned off and which resets said off ramp voltage while said pulse control signal is turned on, wherein said off ramp voltage has a slope which is inversely proportional to an off time of said pulse control signal; and
a first comparator which asserts an on signal when said off ramp voltage compares favorably with said error voltage;
an on ramp network, comprising:
an on ramp generator which generates an on ramp voltage while a pulse control signal is turned on and which resets said on ramp voltage while said pulse control signal is turned off, wherein said on ramp voltage has a slope which is proportional to said input voltage; and
a second comparator which asserts an off signal when said on ramp voltage compares favorably with said reference voltage; and
a pulse control network which turns on said pulse control signal upon each assertion of said on signal and which turns off said pulse control signal upon each assertion of said off signal.

9. The constant on-time voltage regulation system of claim 8, wherein said error network, said off ramp network, said on ramp network, and said pulse control network are provided on an integrated circuit.

10. The constant on-time voltage regulation system of claim 8, wherein said off ramp generator comprises:
a current source which develops an off ramp current proportional to said input voltage multiplied by said output voltage and divided by a difference between said input voltage and said output voltage; and
a capacitance which is charged by said off ramp current.

11. The constant on-time voltage regulation system of claim 10, further comprising an output voltage simulation network which develops a value indicative of said output voltage based on said input voltage and said duty cycle of said pulse control signal.

12. The constant on-time voltage regulation system of claim 8, further comprising:
a switch network coupled to an input node receiving said input voltage for switching a phase node based on said pulse control signal;
an inductance having a first end coupled to said phase node and having a second end coupled to an output node developing said output voltage;
an output capacitance coupled to said output node; and
an output voltage sensor coupled to said output node and providing said feedback voltage.

13. The constant on-time voltage regulation system of claim 12, wherein said switch network comprises a pair of electronic switch devices coupled between said input node and ground having an intermediate junction coupled to said phase node, wherein said electronic switch devices are alternatively activated based on said pulse control signal.

14. The constant on-time voltage regulation system of claim 12, wherein said output capacitance comprises a multilayer ceramic capacitor.

15. The constant on-time voltage regulation system of claim 9, wherein said error network comprises an adder which subtracts said reference voltage from said feedback voltage to provide said error voltage.

16. A method of controlling conversion of an input voltage to an output voltage, comprising:
receiving a sense voltage indicative of the output voltage;
comparing the sense voltage with a reference voltage and providing an error voltage indicative thereof;
generating an off ramp voltage while a pulse control signal is turned off and resetting the off ramp voltage while the pulse control signal is turned on, wherein the off ramp voltage has a slope which is inversely proportional to an off time of the pulse control signal;
comparing the off ramp voltage with the error voltage and turning on the pulse control signal when the off ramp voltage compares favorably with the error voltage;
generating an on ramp voltage while a pulse control signal is turned on and resetting the on ramp voltage while the pulse control signal is turned off, wherein the on ramp voltage has a slope that is proportional to the input voltage; and
comparing the on ramp voltage with the reference voltage and turning off the pulse control signal when the on ramp voltage compares favorably with the reference voltage.

17. The method of claim 16, wherein said generating an off ramp voltage comprises generating the off ramp voltage having a slope which is proportional to the input voltage multiplied by the output voltage divided by the difference between the input voltage and the output voltage.

18. The method of claim 17, further comprising simulating the output voltage based on the input voltage and a duty cycle of the pulse control signal.

19. The method of claim 16, wherein said generating an off ramp voltage comprises:
subtracting a first value indicative of the output voltage from a second value indicative of the input voltage to provide a difference value;
dividing the first value by the difference value to provide a third value;
multiplying the third value by a fourth value indicative of the input voltage to provide a control value;
generating a control current proportional the control value; and
charging a capacitance with the control current.

20. The method of claim 19, further comprising:
sampling the off ramp voltage using the pulse control value to provide a peak off ramp value;
amplifying a difference between the peak off ramp value and a reference value indicative of the reference voltage to provide a correction factor;
subtracting a first value indicative of the output voltage from a second value indicative of the input voltage to provide a difference value;
dividing the first value by the difference value to provide a third value;
multiplying the third value by a fourth value indicative of the input voltage to provide a fifth value;
multiplying the fifth value by the correction factor to provide a sixth value;
adding the fifth and sixth values to provide a control value;
generating a control current proportional the control value; and
charging a capacitance with the control current.
